(19) United States
(12) Patent Application Publication
(10) Pub. No.: US 2004/0081879 A1
(43) Pub. Date: Apr. 29, 2004

(54) Fuel cell bipolarplate

(76) Inventors: Mineo Washima, Tokyo (JP); Masahiro Seido, Tokyo (JP); Tatsuya Tonogi, Tokyo (JP)

Correspondence Address: Robert F. I. Conte, Barnes & Thornburg, P.O. Box 2786, Chicago, IL, 60690-2786, US

(21) Appl. No.: 10/689,166

(22) Filed: Oct. 20, 2003

(30) Foreign Application Priority Data
Oct. 18, 2002 (JP) 2002-304534

(51) Int. Cl. H01M 8/02; H01M 8/10; H01M 4/94; H01M 8/24

(52) U.S. Cl. 429/34; 429/32; 429/44; 429/38

(57) ABSTRACT

A fuel cell bipolarplate has: a bipolarplate substrate that is of only a corrosion-resisting metallic material or a composite composed of a corrosion-resisting metallic material to define the surface layer of the composite and the other metallic material to define the inner layer of the composite; and a conductive contact layer that is formed on the bipolarplate substrate, the conductive contact layer being of noble metal and having a thickness of 0.0005 μm or greater and less than 0.01 μm.

The present application is based on Japanese patent application No.2002-304534, the entire contents of which are incorporated herein by reference.

### BACKGROUND OF THE INVENTION

1. Field of the Invention

This invention relates to a fuel cell bipolarplate for polymer electrolyte fuel cell (hereinafter referred to as PEFC).

2. Description of the Related Art

FIG. 1 is a cross sectional view showing the basic composition of conventional polymer electrolyte fuel cell using graphite bipolarplates.

An MEA (membrane-electrode assembly) 64 is composed of: a polymer electrolyte membrane 61 which is of electrolyte; and a fuel electrode 62 and an oxidant electrode 63 which have anode and cathode catalyst layers, respectively, located on both surfaces of the polymer electrolyte membrane 61 and gas diffusion layers located outside the catalyst layers.

The FC (fuel cell) cells 60 are constructed such that a pair of graphite bipolarplates 67, 68, which section the surface of MEA 64 to define fuel gas flow paths 65 and oxidant gas flow paths 66, sandwich the MEA 64 while being pressed at a suitable pressure to seal the ends of MEA 14, with gaskets 69, 70.

The FC cells 60 are heated to about 80° C. and generate power by electrochemical reaction using hydrogen in fuel gas and oxygen in oxidant gas.

When hydrogen in fuel gas to flow fuel gas flow path contacts a catalyst of fuel electrode 62, the next reaction occurs.

2H₂→4H⁺+4e⁻

H⁺ moves in the polymer electrolyte membrane 61 of MEA 64, reaching the catalyst of oxidant electrode 63, being reacted with oxygen in oxidant gas to flow the oxidant gas flow path 66, so that water is generated.

4H⁺+4e⁻+O₂→2H₂O

The above electrode reaction gives electromotive force and current is taken out through the bipolarplates 67, 68.

The FC is generally composed in a stack of PEFC cells as above-mentioned. In fact, the PEFC cells as shown in FIG. 1 are not simply stacked, and there are a variety of stacking patterns so as to stack them efficiently.

An example of metallic bipolarplate to be substituted for the conventional graphite bipolarplate is a bipolarplate of stainless steel. However, it is known that components of the stainless steel are eluted to degrade the cell characteristic when using the surface as it is.

Japanese patent application laid-open Nos. 10-228914 (prior art 1) and 2001-93538 (prior art 2) disclose, as a solution, a bipolarplate that acid-resisting coating such as Ta, Zr, Nb and Ti is formed on a stainless steel substrate and noble metal such as Au is plated 0.01 to 0.06 μm on the surface of acid-resisting coating. Such a thin noble metal film is necessarily porous and cannot completely cover the surface of stainless steel.

The bipolarplate described above has good conductivity but is incomplete in corrosion resistance. During long operation, components of stainless steel will be eluted out to degrade the cell characteristics.

The PEFC is generally composed in a stack of PEFC cells and the PEFC cells are composed such that a composite of two electrodes (fuel and oxidant electrodes) and a polymer electrolyte membrane to be sandwiched by the two electrodes is sandwiched by bipolarplates with fuel gas flow path and oxidant gas flow path.

One of problems in expanding the use of FC is high manufacturing cost. So, it is important that the cost of cells with electrodes as main component of FC is reduced as much as possible.

When FC is mounted on automobiles, it is required to be miniaturized and lightened. Accordingly, in order to realize a low-cost, miniaturized and lightened FC, metallic bipolarplates are researched instead of the conventional microstructured carbon bipolarplates.

The metallic bipolarplate is needed to have performances that the contact resistance to electrode is low and the corrosion resistance is good. Japanese patent application laid-open No.06-349508 (prior art 3) discloses a metallic bipolarplate with plated layer that satisfies the performances.

In the conventional metallic bipolarplates, in order to prevent pinhole from occurring in plated layer formed on metallic substrate, the plated layer of noble metal need have a considerable thickness. Therefore, it is impossible in cost to release such a product. If not having the required thickness, metal ions are eluted from pinhole to degrade the cell characteristic. In this regard, the thickness of Au plated layer described in prior arts 1 and 2 is a limit of thickness to prevent the pinhole.

The inventors have researched a low-cost bipolarplate made by such a method that corrosion-resisting layer of Ti etc. is formed on a metallic plate and conductive coating is formed thereon. This method can offer a good reliability. However, the conductive coating material is difficult to handle and to use since it uses essentially the tunnel characteristic of current. Also, a certain degree of contact resistance is generated, resulting in IR loss.

### SUMMARY OF THE INVENTION

It is an object of the invention to provide a fuel cell bipolarplate that has a good contact resistance and a good corrosion resistance to give a high voltage generation characteristic as well as having a reduced manufacturing cost.

According to the invention, a fuel cell bipolarplate for providing a gas flow path while being disposed at both sides of MEA, comprises:

a bipolarplate substrate that is of only a corrosion-resisting metallic material or a composite composed of a corrosion-resisting metallic material to define the surface layer of the composite and the other metallic material to define the inner layer of the composite; and

a conductive contact layer that is formed on the bipolarplate substrate, the conductive contact layer being of noble metal and having a thickness of 0.0005 μm or greater and less than 0.01 μm.

Further, according to the invention, a fuel cell bipolarplate for providing a gas flow path while being disposed at both sides of MEA, comprises:

a bipolarplate substrate that is of only a corrosion-resisting metallic material or a composite composed of a corrosion-resisting metallic material to define the surface layer of the composite and the other metallic material to define the inner layer of the composite; and

a conductive contact layer that is formed on the bipolarplate substrate, the conductive contact layer being of carbon or a composite compound with a bandgap of 0.6 eV or less and having a thickness of 0.0005 μm or greater and less than 0.01 μm.

In this invention, instead of the conventional metallic bipolarplate substrate of stainless steel with plated layer of noble metal, a bipolarplate substrate composed of Ti series corrosion-resisting material with conductive contact layer of noble metal is provided. Thus, the corrosion-resisting material layer and the conductive contact layer respectively are assigned separately to functions of corrosion resistance and conductivity. Thereby, the thickness of noble metal layer (conductive contact layer) can be reduced to the limit while keeping a given conductivity since the occurrence of defect (pinhole) in noble metal layer does not matter. There, the manufacturing cost of bipolarplate can be reduced by that much.

The function of bipolarplate is not only to collect current from electrode but also to deliver fuel and oxygen to the entire MEA, and therefore it is generally provided with a groove or dimple. The groove portion does not have to be conductive and the rib face to contact the gas diffusion layer of MEA only has to be conductive. By selectively forming noble metal layer on the rib face, the conductivity can be secured sufficiently and the amount of noble metal used can be reduced to lower the cost. This effect is characteristic of Ti series corrosion-resisting material. In the stainless steel bipolarplate substrate, component ions are eluted out from the defect (penetrating pinhole) generated in noble metal layer. Compared to this, Ti series corrosion material is only subjected to oxidation without causing the elution of component ions while the electrical resistance increases slightly.

The groove portion other than the rib face of bipolarplate is preferably covered with titanium oxide without having the conductive contact layer of noble metal. The surface of titanium oxide layer to cover the groove portion is hydrophilic and therefore water generated is easy to flow and discharge. This prevents electrochemical reaction from being inhibited by delaying of generated water. Thus, to cover the groove portion with the titanium oxide layer is effective for improving the cell voltage output.

### BRIEF DESCRIPTION OF THE DRAWINGS

The preferred embodiments according to the invention will be explained below referring to the drawings, wherein:

FIG. 1 is a cross sectional view showing the basic composition of conventional polymer electrolyte fuel cell using graphite bipolarplates;

FIG. 2 is a cross sectional view showing the basic composition of a polymer electrolyte fuel cell in a preferred embodiment according to the invention;

FIG. 3 is an enlarged cross sectional view showing the details of bipolarplates 17, 18;

FIG. 4 is an enlarged cross sectional view showing a modification of the bipolarplates 17, 18;

FIG. 5 is an enlarged cross sectional view showing a pinhole 22 that may exist in conductive contact layer 21;

FIGS. 6A and 6B are explanatory cross sectional views showing oxidation within the pinhole 22 in the conductive contact layer 21 of bipolarplate of the invention;

FIG. 6C is explanatory cross sectional views showing corrosion within a pinhole 52 in conductive contact layer 51 of conventional bipolarplate; and

FIG. 7 is a graph showing I-V characteristics after 100 hour operation in a single cell made using the bipolarplate of Examples of the invention and comparative examples.

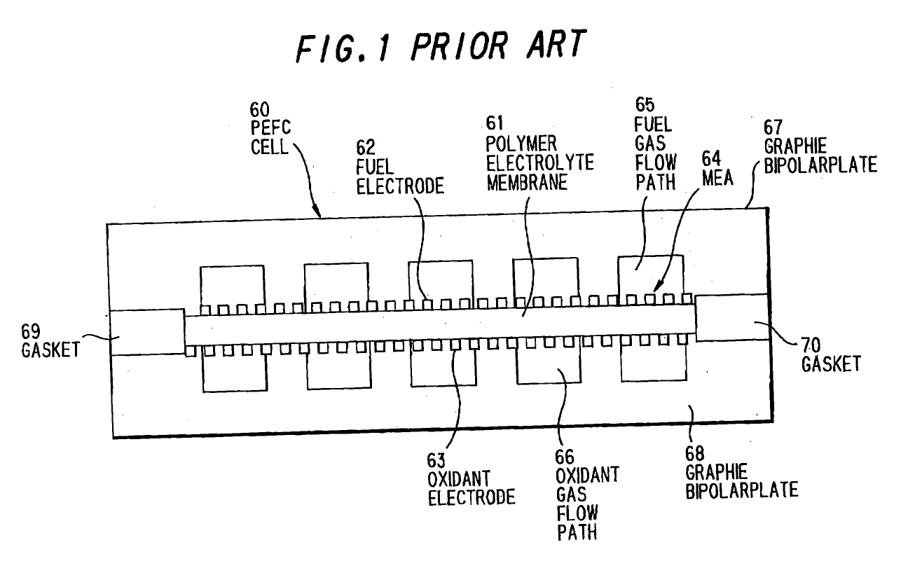

### DETAILED DESCRIPTION OF THE PREFERRED EMBODIMENTS

A fuel cell bipolarplate in a preferred embodiment according to the invention will be detailed below in reference to the drawings.

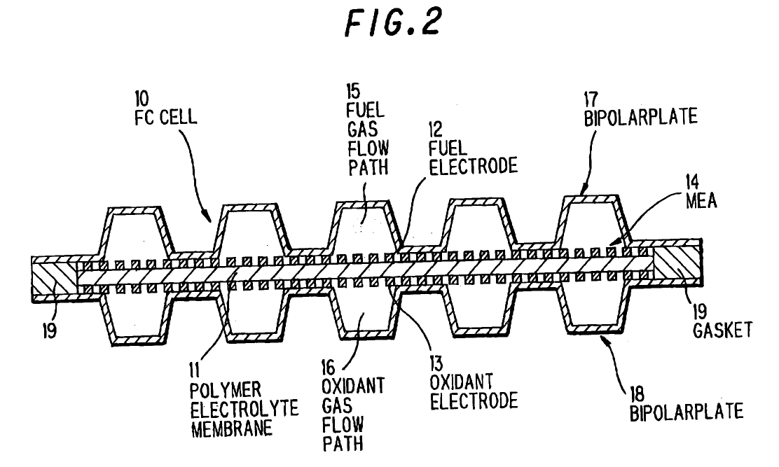

FIG. 2 is a cross sectional view showing FC cells 10 using the fuel cell bipolarplate in the embodiment.

An MEA (membrane-electrode assembly) 14 is composed of: a polymer electrolyte membrane 11 which is of electrolyte; and a fuel electrode 12 and an oxidant electrode 13 which have anode and cathode catalyst layers, respectively, located on both surfaces of the polymer electrolyte membrane 11 and gas diffusion layers located outside the catalyst layers.

The FC cells 10 are constructed such that metallic bipolarplates 17, 18, which section the surface of MEA 14 to define fuel gas flow paths 15 and oxidant gas flow paths 16, sandwich the MEA 14 while sealing the ends of MEA 14 with gaskets 19.

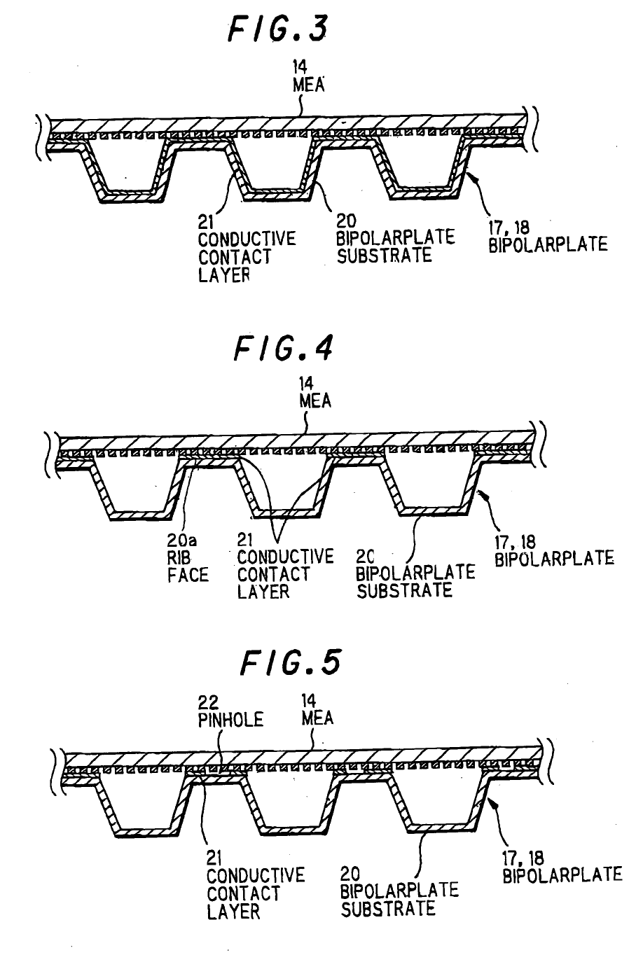

FIG. 3 is an enlarged cross sectional view showing the details of bipolarplates 17, 18.

The bipolarplates 17, 18 are composed of: a bipolarplate substrate 20 which is of a corrosion-resisting metallic material such as Ti and Ti alloys or a composite that a corrosion-resisting metallic material such as Ti and Ti alloys is formed as cladding material on the surface of SUS etc.; and a conductive contact layer 21 which is of noble metal etc. and is formed on the surface of bipolarplate substrate 20 to face the MEA 14.

FIG. 4 is an enlarged cross sectional view showing a modification of the bipolarplates 17, 18.

As shown in FIG. 4 the conductive contact layer 21 may be formed only on a rib face 20a of the bipolarplate substrate 20 to face the MEA 14, while it is formed on the entire surface of bipolarplate substrate 20 in FIG. 3. In this modification, the bipolarplates 17, 18 can be manufactured at lower cost.

FIG. 5 is an enlarged cross sectional view showing a pinhole 22 that may exist in the conductive contact layer 21.

The conductive contact layer 21 has a thickness of 0.0005 μm (0.5 nm) or greater and less than 0.01 μm (10 nm) and may include the microscopic pinhole 22 as shown in FIG. 5. However, the bipolarplate substrate 20 is of a corrosion-resisting material such as Ti or Ti alloys and, thereby, the corrosion of bipolarplate substrate 20 within the pinhole 22 can be prevented from making further progress, so that stable characteristics of power generation can be obtained. Also, the contact resistance of the bipolarplates 17, 18 to the gas diffusion layer of MEA 14 (i.e., the outer layer of electrode 12 or 13 located at the bipolarplate side) is 8 mΩ/cm² or less such that it is significantly lower than that of the conventional bipolarplates which is of microstructured graphite. Thus, the bipolarplates 17, 18 offer excellent conductivity.

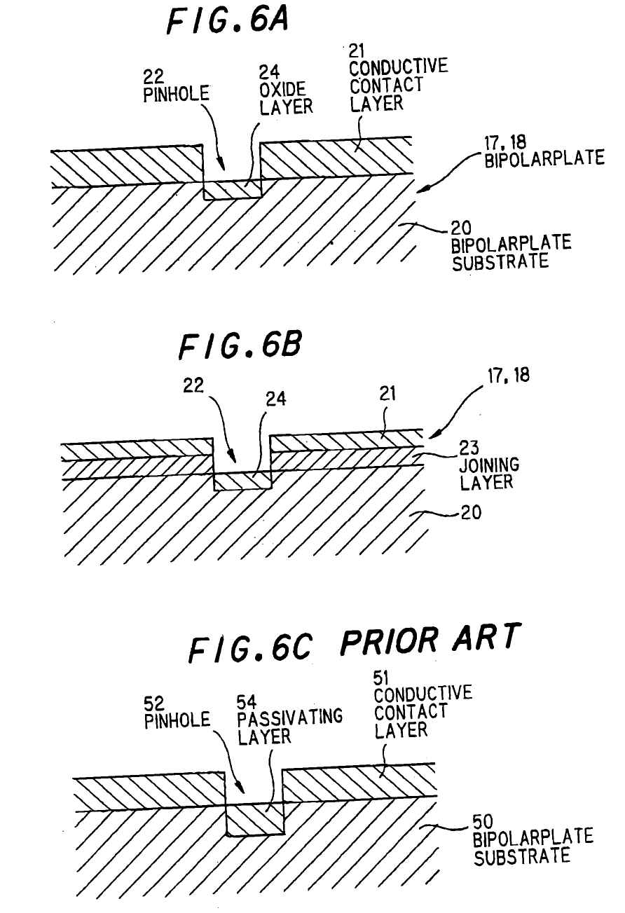

FIGS. 6A and 6B are explanatory cross sectional views showing the conductive contact layer 21 which is formed on the bipolarplate substrate 20 of bipolarplates 17, 18.

As shown in FIG. 6A, the conductive contact layer 21 may be formed directly on the bipolarplate substrate 20 by plating etc. and alternatively, as shown in FIG. 6B, may be formed through joining layer 23 on the bipolarplate substrate 20.

As shown in FIGS. 6A and 6B, there may exist a microscopic pinhole 22 in the conductive contact layer 21 to expose the bipolarplate substrate 20 to MEA 14. However, oxide layer 24 is formed on the exposed surface of bipolarplate substrate 20 within the pinhole 22 and, thereby, the corrosion within the pinhole 22 can be prevented from making further progress while the contact resistance lowers slightly.

As compared to this, in case of conventional bipolarplate composed of bipolar substrate 50 of SUS and conductive contact layer 51 of noble metal as shown in FIG. 6C, the corrosion of bipolar substrate 50 cannot be prevented from making progress while passivating layer 54 of SUS is formed within pinhole 52, causing elution of components from the bipolar substrate 50.

The bipolarplate substrate 20 used in the embodiment of the invention may be a corrosion-resisting material such as Ti and Ti alloys or a composite that a cladding layer of a corrosion-resisting material such as Ti and Ti alloys is formed on the surface of SUS etc., e.g., a composite of Ti/Al/Ti, Ti/SUS/Ti etc., where the plate has a thickness of about 0.3 mm and the Ti cladding layer has a thickness of about 30 μm.

The conductive contact layer 21 may be of noble metal such as Au, Pt, Ru and Pd that has a thickness of 0.0005 μm (0.5 nm) or greater and 0.01 μm (10 nm) or less, or it is of a composite compound, which has a bandgap of 0.6 eV or less, such as carbon, TiN, TiC, TiB, TiNC and TiNCB that has a thickness of 0.0005 μm (0.5 nm) or greater and 0.1 μm (100 nm) or less.

The joining layer 23 to join the conductive contact layer 21 to the bipolarplate substrate 20 if necessary may be of Ti, Ni, Ta, Nd or Pt that has a thickness of 0.0005 μm (0.5 nm) or greater and 0.05 μm (50 nm) or less.

The bipolarplates 17, 18 as shown in FIGS. 2 to 5 may be made such that a bipolarplate substrate 20 with a shape of flat plate is first processed to have grooves by pressing and then conductive contact layer 21 is formed on the surface of the bipolarplate substrate 20. Alternatively, they may be made such that conductive contact layer 21 is first formed on the entire surface or necessary part of the surface of bipolarplate substrate 20 with a shape of flat plate and then is processed to have grooves by pressing. The latter is advantageous because of the workability of plating and processability of pressing, where, in case of Ti, it is easier to process the plate with covering layer (conductive contact layer 21). Whichever way the bipolarplate is made by, the fuel cell can have the same characteristics.

Examples of fuel cell bipolarplate according to the invention are explained below, as compared to comparative examples.

### EXAMPLES 1 TO 3

Table 1 shows the comparison of composition and fuel cell characteristics between examples 1-3 of the invention and comparative examples 1-7 (comp 1 to comp 7 in Table 1).

TABLE 1

| | | Example 1 | Example 2 | Example 3 | Comp 1 | Comp 2 |
|---|---|---|---|---|---|---|
| Bipolarplate substrate | | Ti/Al/Ti | Ti | Ti/SUS/Ti | Ti/Al/Ti | SUS316 |
| Thickness (mm) of | | 0.3 | 0.2 | 0.3 | 0.3 | 0.3 |
| substrate | | | | | | |
| Thickness (μm) of Ti | | 30 | — | 30 | 30 | — |
| layer | | | | | | |
| Conductive | material | Au | Au | Au | graphite coating | Au |
| contact | thickness | 5 | 5 | 5 | 30,000 | 20 |
| layer | (nm) | | | | | |
| Joining | material | — | — | Ti | — | — |
| layer | thickness | — | — | 5 | — | — |
| | (nm) | | | | | |

| Contact | 7 | | 8 | | 6 | | 20 | | 9 | |
|---|---|---|---|---|---|---|---|---|---|---|
| resistance (m Ω · cm²) | | | | | | | | | | |
| before operation | | | | | | | | | | |
| Corrosion-resisting | ◯*1 | | ◯ | | ◯ | | ◯ | | X*1 | |
| property (polarization | | | | | | | | | | |
| property) | | | | | | | | | | |
| Cell operation time (hr) | 1 | 100 | 1 | 100 | 1 | 100 | 1 | 100 | 1 | 100 |
| Cell characteristic/ | ◯*2 | ◯ | ◯ | ◯ | ◯ | ◯ | Δ*2 | Δ | ◯ | X*2 |
| Generated voltage V | 0.63 | 0.60 | 0.64 | 0.60 | 0.66 | 0.65 | 0.53 | 0.52 | 0.63 | 0.42 |
| at 0.5 A/cm² | | | | | | | | | | |
| Contact | 8 | 8 | 9 | 9 | 7 | 7 | 22 | 23 | 11 | 15 |
| resistance (m Ω · cm²) | | | | | | | | | | |
| after operation | | | | | | | | | | |

| | | | | | |
|---|---|---|---|---|---|
| Cost | ◯*3 | ◯ | ◯ | X*3 | Δ*3 |

| | | Comp 3 | Comp 4 | Comp 5 | Comp 6 | Comp 7 |
|---|---|---|---|---|---|---|
| Bipolarplate substrate | | SUS316 | graphite | Ti | Ti/Al/Ti | SUS318 |
| Thickness (mm) of | | 0.5 | 2 | 0.2 | 0.3 | 0.3 |
| substrate | | | | | | |
| Thickness (μm) of Ti | | — | — | — | 30 | — |
| layer | | | | | | |
| Conductive | material | Au | — | Au | none | none |
| contact | thickness | 5,000 | — | 50 | — | — |
| layer | (nm) | | | | | |
| Joining | material | — | — | — | — | — |
| layer | thickness | — | — | — | — | — |
| | (nm) | | | | | |

| Contact | 7 | | 11 | 7 | 7 | 9 |
|---|---|---|---|---|---|---|
| resistance (m Ω · cm²) | | | | | | |
| before operation | | | | | | |
| Corrosion-resisting | ◯ | | ◯ | ◯ | ◯ | X |
| property (polarization | | | | | | |
| property) | | | | | | |
| Cell operation time (hr) | 1 | 100 | 100 | 100 | 100 | 100 |
| Cell characteristic/ | ◯ | ◯ | ◯ | ◯ | X | X |
| Generated voltage V | 0.65 | 0.63 | 0.64 | 0.62 | 0.25 | 0.15 |
| at 0.5 A/cm² | | | | | | |
| Contact | 8 | 8 | 8 | 7 | 60 | 45 |
| resistance (m Ω · cm²) | | | | | | |
| after operation | | | | | | |

| | | | | | |
|---|---|---|---|---|---|
| Cost | X | X | Δ | — | — |

*1◯: good, X: bad
*2◯: good, Δ: not so good, X: bad
*3◯: very low, Δ: low, X: high

Example 1 is a bipolarplate composed of a substrate of Al with Ti cladding layer as corrosion-resisting material and 5 nm thick Au conductive contact layer formed on the Ti cladding layer. Example 2 is a bipolarplate composed of a substrate of Ti only and 5 nm thick Au plated layer formed on the Ti substrate. Example 3 is a bipolarplate composed of a substrate of SUS with Ti cladding layer as corrosion-resisting material, 5 nm thick Ti joining layer formed on the Ti cladding layer by vapor deposition and 5 nm thick Au plated layer formed on the joining layer. The joining layer and the conductive contact layer are made such that the Ti corrosion-resisting surface of Ti-cladded substrate is polished to remove the oxide layer and then those layers are formed thereon by vapor deposition.

Comparative example 1 is a bipolarplate composed of a substrate of Al with Ti cladding layer as corrosion-resisting material and 30 μm thick graphite conductive contact layer formed on the Ti cladding layer. Comparative example 2 is a metallic bipolarplate composed of SUS316 and 20 nm thick Au plated layer Comparative example 3 is a metallic bipolarplate composed of SUS316 and 5 μm thick Au plated layer. Comparative example 4 is a conventional bipolarplate composed of graphite only. Comparative example 5 is a bipolarplate composed of a substrate of Ti only and 5 nm thick Au plated layer. Comparative example 6 is a bipolarplate composed of a substrate of Al with Ti cladding layer. Comparative example 7 is a bipolarplate composed of SUS316 only.

In Examples 1 to 3, the contact resistance is 6 to 9 m Ωcm², which is as low as or less than that of Comparative example 4 of conventional graphite. Furthermore, the value changes little between before and after the cell characteristics test.

Especially, the contact resistance of Example 3, in which 5 nm thick Ti layer is inserted between Ti corrosion-resisting layer and bipolarplate substrate to improve the adhesion therebetween, is very-low, 0.7 Ωcm². In addition, the Au conductive contact layer is very thin, 5 nm and therefore the material cost is reduced.

In Comparative examples 6 (Ti cladding layer) and 7 (SUS only) with no conductive contact layer, the contact resistance is low before the cell characteristics test where the surface of bipolarplate is kept polished, but it drastically becomes high after the test because of oxide layer or passivating layer shown in FIG. 6C. In Comparative example 1 with 30 μm graphite coating as conductive contact layer, it has a reliability in a long period but the contact resistance does not fall below 20 Ωcm².

Table 1 also shows the results of polarization property measured to evaluate the corrosion resistance of bipolarplate. In Examples 1 to 3, Comparative examples 1, 5 and 6 with Ti corrosion-resisting layer and Comparative example 4 of graphite, there is no reaction in polarization property regardless of the existence of cladding layer. However, in Comparative examples 7 (SUS only) and 2 (SUS with 20 nm thick Au plated layer) there is found a reaction in polarization property, which proves that there exists ionic elution of components, while there is no reaction in polarization property in Comparative example 3 (SUS with 5 μm thick Au plated layer).

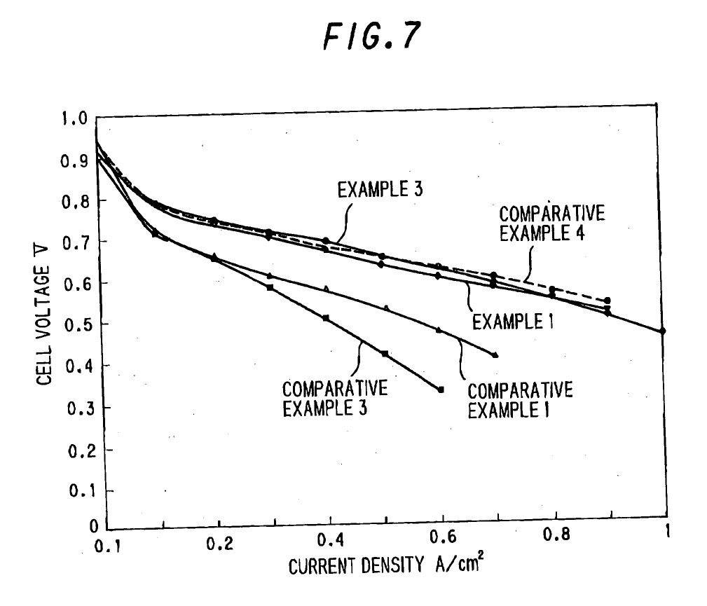

FIG. 7 is a graph showing I-V characteristics after 100 hour operation in a single cell made using the bipolarplate of Examples 1, 3 and Comparative examples 1, 3 and 4.

Comparative example 4, graphite bipolarplate, has grooves, which are obtained by mechanically processing sintered graphite, and a rectangular shape in rib surface, and it offers reference I-V characteristics.

The other metallic bipolarplates have similar rib grooves formed by pressing.

Table 1 also shows voltage generated at current density of 0.5 A/cm² at operation times of 1 hour and 100 hours. The higher the voltage is, the better the cell characteristic is.

Examples 1, 3 (Ti corrosion-resisting bipolarplate) have the same characteristic as graphite bipolarplate (Comparative example 4) which has a generated voltage of higher than 0.6 V.

Especially, Example 3 (Ti corrosion-resisting bipolarplate with conductive contact layer and joining layer) has a stable voltage generation characteristic even after 100 hour operation.

The voltage generation characteristic has a correlation to the contact resistance of bipolarplate material. Comparative examples 6 (with Ti cladding layer) and 7 (SUS only) with no conductive contact layer have bad voltage generation characteristic because of the change in contact resistance.

Comparative example 1 with 30 μm graphite coating as conductive contact layer has a lower generated voltage because of high contact resistance, 20 mΩcm² or higher. However, the generated voltage changes little with time.

In Comparative examples 2, 3 using the bipolar substrate of SUS, the cell characteristics change depending on thickness of Au plated layer. When the thickness is sufficiently as thick as 5 μm (Comparative example 3), the voltage generation characteristic of cell is good. However, when the thickness is as thin as 20 nm (Comparative example 2), the characteristic lowers with time while the initial characteristic of cell is good. Therefore, when SUS is used as bipolarplate substrate, it is necessary for the conductive contact layer to have a thickness of micrometers.

Comparative example 5, Ti substrate with 50 nm Au plated layer has a good characteristic, but it is costly because it uses much Au.

The cell characteristic of metallic bipolarplate highly depends on shape of surface and kind of material thereof. The reasons are assumed as described below.

The conductive contact layer of surface is formed by vapor plating offering relatively little defect, Plated layer formed by general plating is very porous and therefore it is necessary for the layer to have a thickness of 4 to 5 μm not to have defect in covering the surface with plated layer. However, when noble metal such as Au is used as conductive contact layer of bipolarplate to serve as collecting material in fuel cell, it is, from the view point of industrial value, required to reduce the thickness as thin as 1/1000. In plated layer with a thickness of 0.01 to 0.5 μm, there exist many penetrating pinholes. The behavior of penetrating pinholes is considered referring to FIGS. 6A to 6C again.

In case of conventional SUS bipolarplate 50 shown in FIG. 6C, within the penetrating pinhole 52, SUS surface is locally exposed and passivating layer 54 is formed, so that ionic components of SUS are eluted therefrom in cell reaction. The metal ions are reacted with negative ions in polymer membrane of PEFC, lowering the conductivity of hydrogen ion (hydronium ions) and degrading the cell characteristics.

In Table 1, Comparative example 3, which is a bipolarplate of SUS substrate with 20 nm Au plated layer, has a good initial cell characteristic but the characteristic degrades with time. This may be caused by elution of metal ions. In case of SUS substrate, Au plated layer to serve as corrosion-resisting layer is needed to have a thickness of about 5 μm (Comparative example 3) and, if it has such a thickness, the cell characteristic becomes good.

Although SUS is descried above as an example, most of metal except for noble metal and Ti series materials has the problem about ion elution and frequently cannot be used as bipolarplate depending on the degree of ion elution.

Compared to this, in the Ti series bipolarplate substrate of the invention, although, as shown in FIG. 6A, the Ti surface is exposed within the penetrating pinhole 22, the conductive contact layer may be thin such that it has such a thickness as several molecules since it serves to secure a current path between the Ti series bipolarplate substrate 20 and the gas diffusion layer of MEA. Considering the uniformity of layer, it may have a thickness of 0.0005 μm (0.5 nm) or greater and less than 0.01 μm (10 nm).

The conductive contact layer 21 may have an insufficient adhesion to bipolarplate substrate depending on the surface state of bipolarplate substrate. So, as shown in FIG. 6, between the conductive contact layer and the Ti series bipolarplate substrate, the Ti joining layer 23 is inserted. Thereby, the adhesion of conductive contact layer 21 to bipolarplate substrate 20 can be improved. This offers is improved contact resistance, enhanced cell characteristics, high reliability and long lifetime.

As described above, for the Ti series bipolarplate substrate 20, the conductive contact layer 21 serves to secure the conductivity. With the bipolarplate substrate 20 being not subjected to dissolution, the conductive contact layer 21 may be porous and extremely thin such that it has degree of freedom of thickness in 0.0005 μm (0.5 nm) or greater and less than 0.01 μm (10 nm)

### EXAMPLES 4 TO 6

Although in Examples 1 to 3 the conductive contact layer 21 is of Au, it may be of a material, other than noble metal, that has conductivity and can prevent the oxidation of Ti.

Table 2 shows Examples 4 to 6 to enable the prevention of Ti oxidation.

TABLE 2

| | | Example 4 | Example 5 | Example 6 |
|---|---|---|---|---|
| Bipolarplate substrate | | Ti/SUS/Ti | Ti/Al/Ti | Ti |
| Thickness (mm) of | | 0.3 | 0.3 | 0.2 |
| substrate | | | | |
| Thickness (μm) of Ti | | 30 | 30 | 30 |
| layer | | | | |
| Conduc- | material | C | TiB | TiN |
| tive | thickness | 50 | 10 | 5 |
| contact | (nm) | | | |
| layer | | | | |
| Joining | material | Ti | Ti | Ti |
| layer | thickness | 5 | 3 | 3 |
| | (nm) | | | |

| Contact | 10 | | 13 | | 11 | |
|---|---|---|---|---|---|---|
| resistance (m Ω · cm²) | | | | | | |
| before operation | | | | | | |
| Corrosion-resisting | ◯*1 | | ◯ | | ◯ | |
| property (polarization | | | | | | |
| property) | | | | | | |
| Cell operation time | 1 | 100 | 1 | 100 | 1 | 100 |
| (hr) | | | | | | |
| Cell characteristic/ | ◯*2 | ◯ | ◯ | ◯ | ◯ | ◯ |
| Generated voltage V | 0.62 | 0.61 | 0.61 | 0.60 | 0.63 | 0.61 |
| at 0.5 A/cm² | | | | | | |
| Contact | 11 | 12 | 13 | 14 | 11 | 10 |
| resistance (m Ω · cm²) | | | | | | |
| after operation | | | | | | |

| | | | |
|---|---|---|---|
| Cost | ◯*3 | ◯ | ◯ |

*1◯: good
*2◯: good
*3◯: very low

As shown in Table 2, the conductive contact layer is of carbon (Example 4), TiB (Example 5) and TiN (Example 6). The bipolarplates are made using joining layer of Ti.

As the result of measuring the cell characteristics, Examples 4 to 6 all have good cell characteristics.

Although Examples 1 to 6 use Ti as corrosion-resisting material, any conductive materials may be used if oxidation or reduction reaction occurs at anode or cathode. Especially, a material with high conductivity is generally preferable to suppress IR loss and a metallic material with easy processability is further preferable.

The noble metal layer (conductive contact layer 21) may be formed on the entire surface of bipolarplate substrate or only on the rib face to face the MEA. Namely, it may be selectively plated to reduce the cost if it serves as low resistance contact.

Although Examples 1 to 6 use pure gold as noble metal layer, platinum or alloys thereof may be used. A third material may be inserted between bipolarplate substrate 20 and conductive contact layer 21.

Although Examples 1 to 6 use vapor plating or vapor deposition to form the noble metal layer, the other method may be used.

The noble metal layer may be thin since there occurs no mechanical friction thereon if it serves as contact member. It may have a thickness of 0.5 to 50 nm. According as the thickness increases, the amount of noble metal increases and the manufacturing cost increases.

Although Examples 1 to 6 relates to PEFC (polymer electrolyte fuel cell) that hydrogen gas and air are reacted, the bipolarplate of the invention is not limited to this and can be also applied to PEFC that hydrogen gas and pure oxygen are reacted. Furthermore, the bipolarplate of the invention can be applied to various fuel cells such as DMFC (direct methanol fuel cell) that methanol and air are reacted.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A fuel cell bipolarplate for providing a gas flow path while being disposed at both sides of MEA, comprising:
a bipolarplate substrate that is of only a corrosion-resisting metallic material or a composite composed of a corrosion-resisting metallic material to define the surface layer of the composite and the other metallic material to define the inner layer of the composite; and
a conductive contact layer that is formed on the bipolarplate substrate, the conductive contact layer being of noble metal and having a thickness of 0.0005 μm or greater and less than 0.01 μm.

2. A fuel cell bipolarplate for providing a gas flow path while being disposed at both sides of MEA, comprising:
a bipolarplate substrate that is of only a corrosion-resisting metallic material or a composite composed of a corrosion-resisting metallic material to define the surface layer of the composite and the other metallic material to define the inner layer of the composite; and
a conductive contact layer that is formed on the bipolarplate substrate, the conductive contact layer being of carbon or a composite compound with a bandgap of 0.6 eV or less and having a thickness of 0.0005 μm or greater and less than 0.01 μm.

3. The fuel cell bipolarplate according to claim 1, wherein:
the conductive contact layer is formed through a joining layer on the bipolarplate substrate.

4. The fuel cell bipolarplate according to claim 2, wherein:
the conductive contact layer is formed through a joining layer on the bipolarplate substrate.

5. The fuel cell bipolarplate according to claim 1, wherein:
the conductive contact layer is formed only on a rib face to contact a conductive gas diffusion layer of MEA.

6. The fuel cell bipolarplate according to claim 2, wherein:
the conductive contact layer is formed only on a rib face to contact a conductive gas diffusion layer of MEA.

7. The fuel cell bipolarplate according to claim 1, wherein:
the corrosion-resisting metallic material is Ti or Ti alloys.

8. The fuel cell bipolarplate according to claim 2, wherein:
the corrosion-resisting metallic material is Ti or Ti alloys.

9. The fuel cell bipolarplate according to claim 7, wherein:
the conductive contact layer is of Au, Pt, Ru or Pd.

10. The fuel cell bipolarplate according to claim 8, wherein:
the conductive contact layer is of any one of carbon, TiN, TiC and TiB or a composite of two or more of carbon, TiN, TiC and TiB.

11. The fuel cell bipolarplate according to claim 9, wherein;
the conductive contact layer is formed through a joining layer on the bipolarplate substrate, and the joining layer is of Ti, Ni, Ta, Nb or Pt and has a thickness of 0.6 nm or greater and 50 nm or less.

12. The fuel cell bipolarplate according to claim 10, wherein:
the conductive contact layer is formed through a joining layer on the bipolarplate substrate, and the joining layer is of Ti, Ni, Ta, Nb or Pt and has a thickness of 0.6 nm or greater and 50 nm or less.

13. The fuel cell bipolarplate according to claim 9, wherein:
the conductive contact layer is formed only on a rib face to contact a conductive gas diffusion layer of MEA, and a groove portion other than the rib face is covered with titanium oxide.

14. The fuel cell bipolarplate according to claim 10, wherein:
the conductive contact layer is formed only on a rib face to contact a conductive gas diffusion layer of MEA, and a groove portion other than the rib face is covered with titanium oxide.
